(19) United States
(12) Patent Application Publication
(10) Pub. No.: US 2020/0005245 A1
(43) Pub. Date: Jan. 2, 2020

(54) EMPLOYER BRAND INDEX

(71) Applicant: Estela Vazquez Perez, Toronto (CA)

(72) Inventor: Estela Vazquez Perez, Toronto (CA)

(21) Appl. No.: 16/022,591

(22) Filed: Jun. 28, 2018

(51) Int. Cl. G06Q 10/10; G06Q 30/02

(52) U.S. Cl. CPC G06Q 10/1053; G06Q 30/0201

(57) ABSTRACT

A method of business is used for gathering insights about employer brand reputation, including candidate and employee preferences, perceptions, and experiences. The method of business provides a normalization of data points into a meaningful index that helps visualize employer reputation in a numerical order. It establishes the strength of the employer relationship with desired people to hire and retain for the organization. The method of business includes the steps of establishing a desired market, conducting market research, gathering market-data, gathering candidate-data, and using the market-data and candidate-data to create an employer-brand-index. Further, it considers how employers fulfill expectations in their desired connection with a company's purpose, how they support the employer vision of the future, compelling career proposals, what it takes to be an ideal employer, most regarded employee experiences, endorsement for people and culture, and a sense of belonging.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of business and more specifically relates to a method of business for gathering insight on employees and talented candidates to measure sentiment and perception of an employer brand and its reputational success.

### 2. DESCRIPTION OF RELATED ART

The world of work is changing rapidly. The world of work today requires a different kind of candidate—the talented, knowledge candidate. Their competencies drive value independent of the organizational setting; they need to continually learn new technologies, tools, and organization structures through diverse career and job experiences. As such, it is becoming increasingly important that an employer knows this and knows how to successfully retain talented candidates and provide effective job experience for employees. Brand health is measured in the business. Every company requires a model to measure the same brand but in the talent market. Some of the metrics are shared as concept but the results as employer are very different. Thus, a suitable solution is desired, an employer brand index is required.

U.S. Pub. No. 2003/0177027 to Anthony DiMarco relates to a multi-purpose talent management and career management system for attracting, developing and retaining critical business talent through the visualization and analysis of informal career paths. The described multi-purpose talent management and career management system for attracting, developing and retaining critical business talent through the visualization and analysis of informal career paths includes historical career data which is collected from an individual and a visual history of their career path is created via graphical views that include career, job and project experiences as well as competencies such as roles, skills, and knowledge. Individuals can use views for career self-assessment, and to develop a differentiating “visual resume”, and to expand their viable career options. Organizations can use these views to recruit talent by helping candidates understand the informal career paths of the organization. The data used to construct the views is stored in a relational database that can be searched to identify talent that meets search criteria. The data can be analyzed to determine a variety of talent metrics such as career and job mobility.

### BRIEF SUMMARY OF THE INVENTION

In view of the foregoing disadvantages inherent in the known method of business art, the present disclosure provides a novel employer brand index. The general purpose of the present disclosure, which will be described subsequently in greater detail, is to provide a normalization of data points into a meaningful index that helps visualize employer reputation in a numerical order. It establishes the strength of the employer relationship with desired people to hire and retain for the organization. Ultimately, it provides an index to measure success at attracting and retaining talent. It removes the guessing when selecting key employee experiences and branding necessary to improve an employer reputation. It tells the talent market who truly is a better employer. It tells the employer what it takes to win talent. The employer brand index may consider how employers fulfill expectations in their desired connection with a company's purpose, how they support the employer vision of the future, compelling career proposals, what it takes to be an ideal employer, most regarded employee experiences, endorsement for people and culture, and a sense of belonging.

A method is disclosed herein. The method may be a method of business for gathering insight about candidate and employee preferences, perceptions, and experiences with an employer. The method includes the steps of establishing a desired market; conducting market research into the desired-market, the market research may include gathering market-data; identifying at least one talented-candidate within the desired-market; and gathering candidate-data from the at least one talented-candidate; and using the market-data and the candidate-data to create an employer-brand-index configured to measure and provide the insight into the candidate and the employee preferences, the perceptions, and the experiences with the employer to promote effective hiring for the employer and proper placement for the talented-candidate as appropriate.

A method of using an employer-brand-index is also disclosed herein. The employment index may be configured to provide insight about candidate and employee preferences, perceptions, and experiences with an employer, and measure the employers' success at attracting and retaining the candidate and employees. The method of using the employer-brand-index may comprise the steps of: providing the employer-brand-index, the employer-index including: a template which may include measurement-criteria, the measurement-criteria being created from establishing a desired market and conducting market research into the desired-market, and wherein the market research includes gathering market-data, identifying at least one talented-candidate within the desired-market, and gathering candidate-data from the at least one talented-candidate; and using the measurement-criteria to measure the employers' the success at attracting and retaining the candidate and employees.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an employer brand index, constructed and operative according to the teachings of the present disclosure.

FIG. 1 is a flow diagram of the method during an ‘in-use’ condition, according to an embodiment of the disclosure.

FIG. 2A is a flow diagram of the method of FIG. 1, according to an embodiment of the present disclosure.

FIG. 2B is a flow diagram of the method of FIG. 1, according to an embodiment of the present disclosure.

FIG. 3 is a flow diagram of the method of FIG. 1, according to an embodiment of the present disclosure.

FIG. 4A relates to the method of FIG. 1, illustrating a template according to an embodiment of the present disclosure.

FIG. 4B relates to the method of FIG. 1, illustrating a template according to an embodiment of the present disclosure.

FIG. 5 is a flow diagram illustrating a method of use for the disclosed invention, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a method of business and more particularly to an employer brand index as used to improve the method of business for gathering insight on employees, community, and talented candidates to measure employer success.

Generally, a framework is provided to gather insight about candidate and employee preferences of an employer. This is called market research architecture and may give the index a structure with an ultimate purpose to establish a baseline number to identify the strength of the relationship of the company as employer with the desired talent market.

The Market research framework may include sensors consistently and methodically selected to deliver market insights and the voice of talented people. It may deliver data and analytics focused on measuring how attractive the brand is to talent, differentiating attributes against recruitment competitors, and if attraction and retention programs are successful with the right people. The variables in the sensors selected may then be evaluated for similarity on concept and measurement and if appropriate, aggregated to the common insight being sought (e.g., work-life balance may be described different by women vs. men).

Local and global market sensors may be used to help the employer adapt to constant change in talent market dynamics and understand preferences in workplaces. The index may identify sensor reports from social, organization, environment, compensation, benefits, and industry activity that impact the employees and candidates. The market sensors may measure specific attributes in the market, for instance job satisfaction is compiled of many check points such as ‘having the right tools, or having clear direction, having the skills to do the job, etc. These check points may be called attributes and most of the time may require normalization to compare results against each market sensor. That is, securing each attribute means and measures the same in the different sensor.

The employer brand index may inform human resources and business segments of strength of relationship with the targeted segments. It may measure culture, engagement in the employee experience, and endorsement for the workplace. It may further measure brand performance connecting to the perceived foundational rewards of the job, team association, enabling for professional growth, and performance rewards. Importantly, it may measure what matters to talented people to consider your company as an ideal employer.

Insights may be given as a way of recommendations to answer questions such as: how people perceive the company as employer; describe the talent voice—preferences of people for ideal employers; why the selected segment should join the company; how people experience the company, etc. Key insights provided may be the strength of relationship with desired talent market and recommendations to distribute investments.

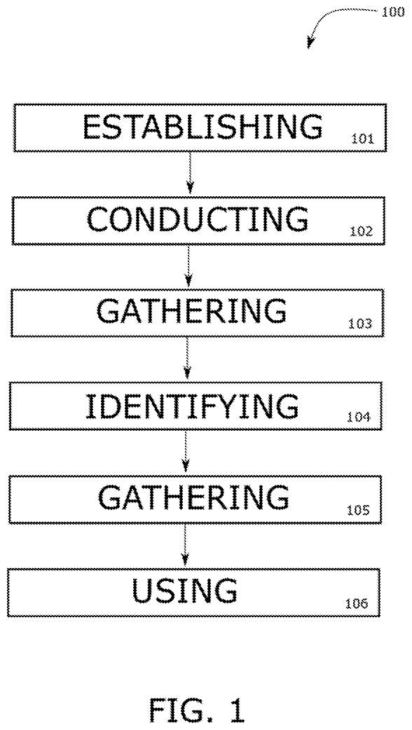

Referring now more specifically to the drawings by numerals of reference, there is shown in FIGS. 1-5, various views of a method 100.

FIG. 1 shows a method of business 100 according to an embodiment of the present disclosure. The method of business 100 may be used for gathering insight about candidate and employee preferences, perceptions, and experiences with an employer. As illustrated, the method of business 100 may include the following steps; step one 101, establishing a desired market; step two 102, defining market research into the desired-market; step three 103, gathering market-data; step four 104, identifying at least one talented-candidate within the desired-market; and step five 105, gathering candidate-data from the at least one talented-candidate; and step six 106, using/correlating the market-data and the candidate-data to create an employer-brand-index configured to measure and provide the insight into the candidate and the employee preferences, the perceptions, and the experiences with the employer to promote effective attraction, hiring, and retention of the talented-candidate as appropriate.

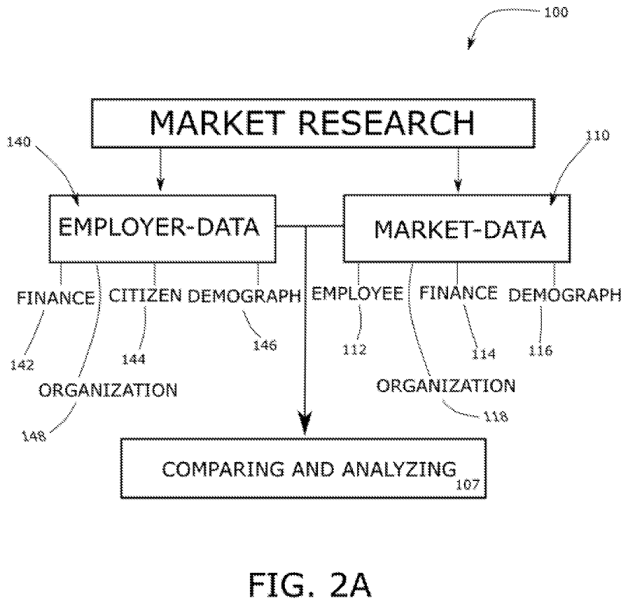

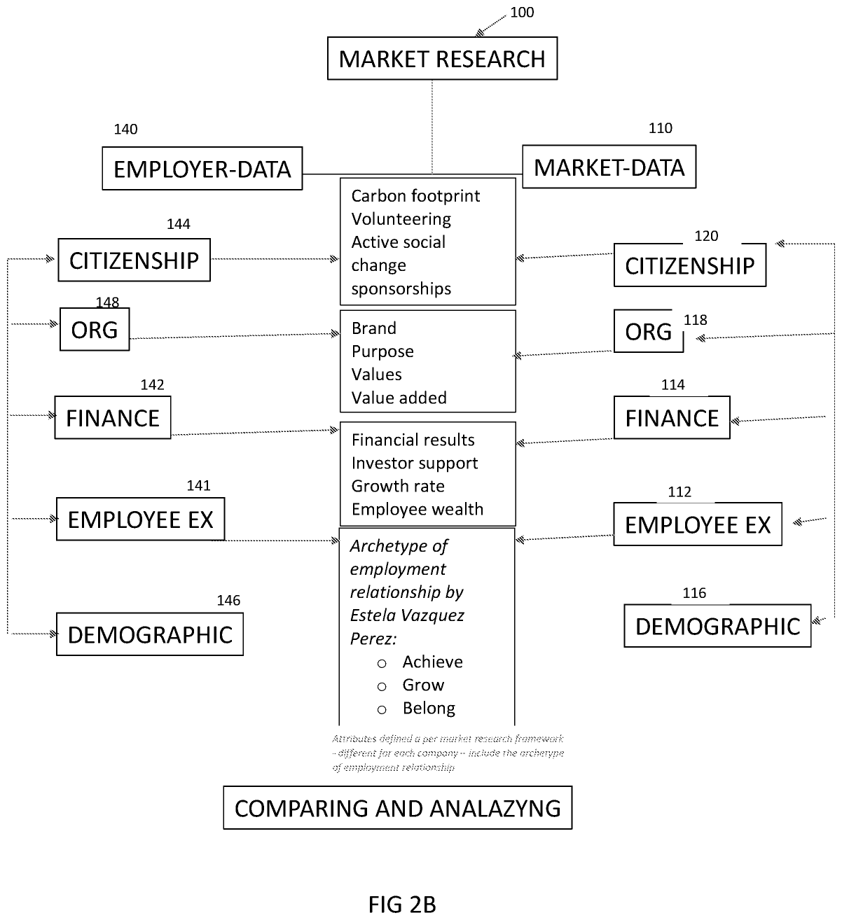

Referring now to FIGS. 2A-2B showing flow diagrams of the method of business 100 of FIG. 1, according to an embodiment of the present disclosure. As above, the method of business 100 may include the steps of conducting market research into the desired-market. In one embodiment, the market research may further include gathering employer-data 140. This employer-data 140 may include information such as perceived employee experience-data 141, financial stability-data 142, citizenship-data 144, demographic-data 146, etc. The employee experience data may specifically include information such as how people achieve, grow, and belong, including trust as employer. 141. The financial stability-data 142 may specifically include information such as, the employers financial standing, investors opinions, growth rate, and trust as business partner. The citizenship-data 144 may specifically include information such as external impacts such as carbon footprint, politics, competition, response to social paradigms, and trust as corporate citizen. Further, the demographic-data 146 may specifically include information such as age distribution, sex distribution, race distribution, health consciousness, safety awareness, behavioral, etc. Last, organization-data 148 may specifically include information about brand, purpose, values, and trust in organizational purpose.

Further, as discussed above, market-data 110 may be gathered via market research. The method of business may then comprise the step of step seven 107, comparing and analyzing the employer-data 140 with the market-data 110. The market-data 110 may include information such as market employee-experience data 112 which may include perception of the experience people may have in the organization in order to achieve, grow and belong; within the desired-market, financial stability-data 114; demographical-data 116 such as age, gender, race, behaviors; within the desired market, organization-data 118; within the desired market, citizenship-data 120. For example, market-employee-experience data 112 within the desired-market may include information on other companies that are in competition with the employer including employee practices to achieve, grow and belong may include information kept on the companies in competition with the employer for the financial stability-data 142, citizenship-data 144 and the demographic-data 146 kept on the employer-data 140. This information may be collected via public records, private records, accounts, social media, etc.

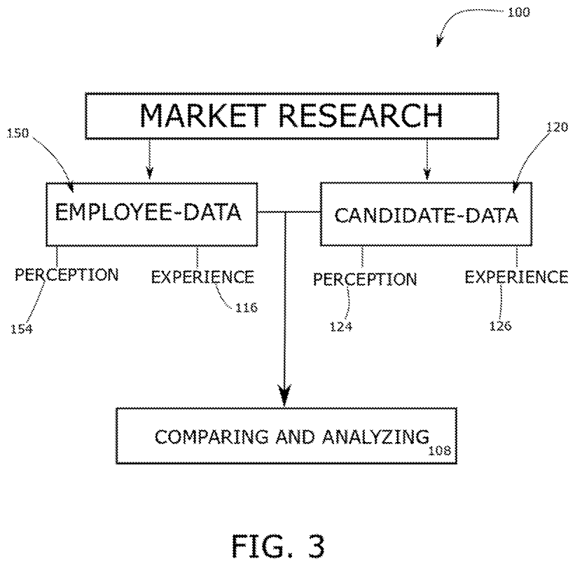

FIG. 3 shows a flow diagram of the method of business 100 of FIG. 1, according to an embodiment of the present disclosure. In one embodiment, the market research may further include identifying at least one employee of the employer and gathering employee-data 150 from the at least one employee. In a preferred embodiment, the employee-data 150 may include at least one employee-perception 154 of the employer and at least one employee-experience 156 with the employer. The at least one employee-perception 154 and the at least one employee-experience 156 may be gathered via interviews, exit interviews, surveys, questionnaires, pulse checks, etc. and may be taken over a course of time. For example, when an employee first begins working for the employer, and then at different times along their employment such as six months, one year, two years, etc. Employee experiences and perceptions may include information such as whether the employee feels fulfilled, whether they feel advancement in their careers, whether they feel sufficiently compensated, their everyday experiences, etc.

Similarly, the candidate-data 120 may include at least one candidate-perception 124 of the employer and at least one candidate-experience 126 with the employer. As above, this information may be collected via interviews, surveys, questionnaires, pulse ratings, etc. Candidate perceptions and experiences may be collected at different times and over multiple times. In one example, the at least one candidate-perception 124 may be taken from the at least one talented-candidate 122 prior to any communication with the employer, during communication with the employer and after communication with the employer. Further, the at least one candidate-experience 126 may be gathered after the communication with the employer (for example, after an interview for a job with the employer) and may be contrasted with prior perceptions and experiences. In this embodiment, the method of business as discussed may further include the step of step eight 108, comparing and analyzing the employee-data 150 with the candidate-data 120 to establish any trends, anomalies, etc.

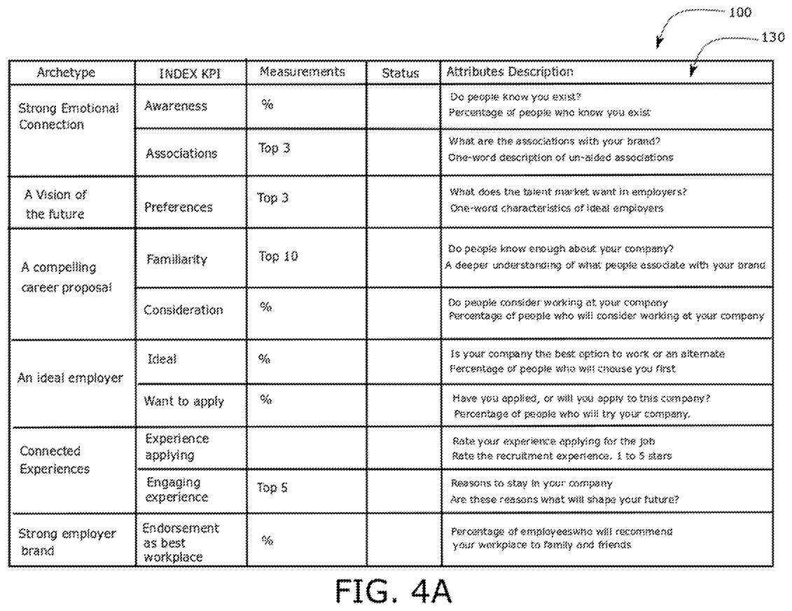

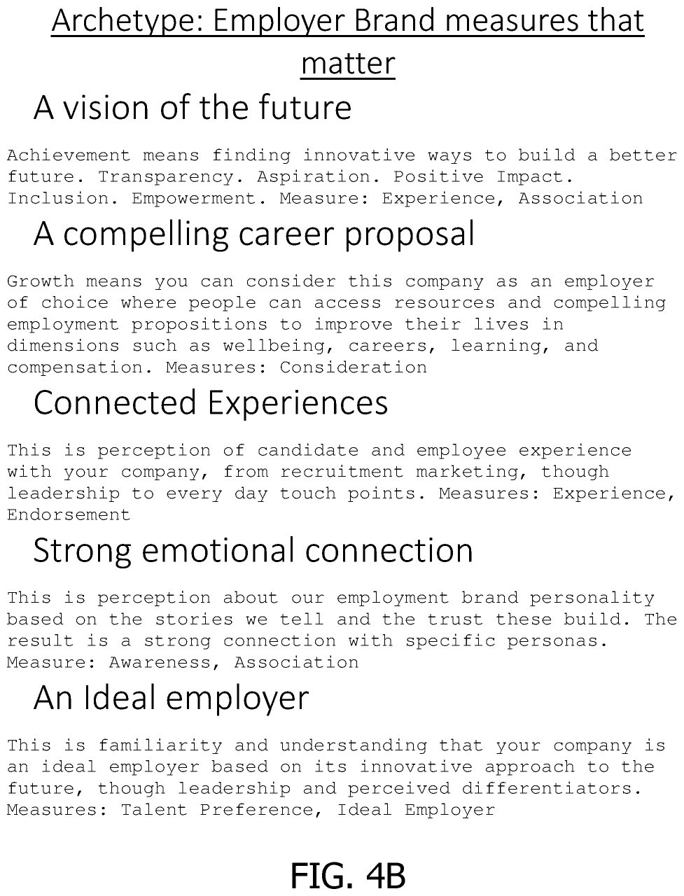

Referring now to FIGS. 4A-4B showing information related to the method of business 100 of FIG. 1, according to an embodiment of the present disclosure. As discussed above, the market research may allow for the creation of the employer-brand-index 130. The employer-brand-index 130 may be provided in many forms. For example, as shown in this figure, the employer-brand-index 130 may be a template used by employers to generate at least one measurement. The template may be a hard copy or an electronic copy.

As shown in this figure, the template may be made up of at least five columns: “archetype”; “index KPI”; “measurements”; “status”; and “attributes description”; and at least six rows. The archetype row may detail different attributes such as “strong emotional connection”; “a vision of the future”; “a compelling career proposal”; “an ideal employer”; “connected experiences”; and “strong employer brand”. The attribute may be measured via multiple performance indicators. For example, for the “strong emotional connection” the performance indicator may include “awareness” which may be measured by a percentage of how many people know the employer exists; and “associations” which may be measured by the top three associations with the employer's brand.

It should be appreciated that the employer-brand-index 130 is not limited to being the template (as a hard copy or electronic copy) and may be provided as a database, a software application, a real-time visualization, etc.

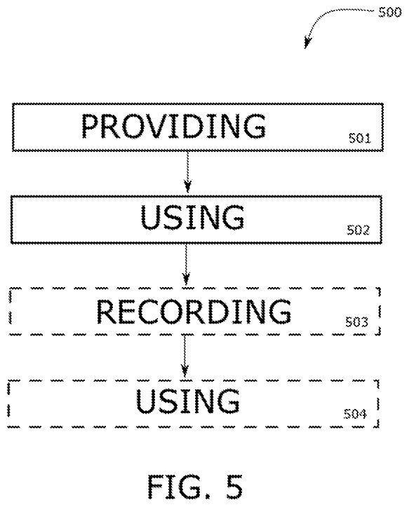

FIG. 5 is a flow diagram illustrating a method of using an employer-brand-index 500, according to an embodiment of the present disclosure. As touched on above, the employer-brand-index may be configured to provide insight about candidate and employee preferences, perceptions, and experiences with the employer, and measure the employers' success at attracting and retaining the candidate and employees. As illustrated, the method of using an employer-brand-index 500 may include the steps of: step one 501, providing the employer-brand-index, the employer-brand-index including the template including measurement-criteria, the measurement-criteria being created from establishing the desired market and conducting the market research into the desired-market, and wherein the market research includes gathering market-data, identifying at least one talented-candidate within the desired-market, and gathering candidate-data from the at least one talented-candidate; and step two 502, using the measurement-criteria to measure the employers' the success at attracting and retaining the candidate and employees.

Further steps may include: step three 503, recording at least one result from the measurement-criteria on the template; and step four 504, using the at least one result from the measurement-criteria to actuate growth of the employer within the desired-market. Further, as discussed above, the market-research may include gathering employer-data, identifying at least one employee of the employer and gathering employee-data from the at least one employee.

It should be noted that step three 503 and step four 504 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method of business for gathering insight about candidate and employee preferences, perceptions, and experiences with an employer comprising the steps of:
establishing a desired market;
conducting market research into the desired-market, the market research including:
gathering market-data;
identifying at least one talented-candidate within the desired-market; and
gathering candidate-data from the at least one talented-candidate; and
using the market-data and the candidate-data to create an employment-index configured to measure and provide said insight into the candidate and said employee preferences, said perceptions, and said experiences with the employer to promote effective hiring for said employer and proper placement for said talented-candidate as appropriate.

2. The method of claim 1, wherein the market research further includes gathering employer-data.

3. The method of claim 2, further comprising the steps of comparing and analyzing the employer-data with the market-data.

4. The method of claim 2, wherein the employer-data includes financial stability-data.

5. The method of claim 4, wherein the employer-data further includes citizenship-data.

6. The method of claim 5, wherein the employer-data further includes demographic-data.

7. The method of claim 1, wherein the market research further includes identifying at least one employee of the employer; and gathering employee-data from the at least one employee.

8. The method of claim 7, wherein the employee-data includes at least one employee-perception of the employer.

9. The method of claim 8, wherein the employee-data further includes at least one employee-experience with the employer.

10. The method of claim 9, further comprising the steps of comparing and analyzing the employee-data with the candidate-data.

11. The method of claim 1, wherein the market-data includes market-employee data within the desired-market.

12. The method of claim 11, wherein the market-data further includes financial stability-data.

13. The method of claim 12, wherein the market-data further includes demographical-data.

14. The method of claim 1, wherein the candidate-data includes at least one candidate-perception of the employer.

15. The method of claim 14, wherein the candidate-data further includes at least one candidate-experience with the employer.

16. A method of using an employment-index, the employment-index configured to provide insight about candidate and employee preferences, perceptions, and experiences with an employer, and measure the employers' success at attracting and retaining said candidate and employees, the method comprising the steps of:
providing the employment-index, the employment-index including:
a template including measurement-criteria, the measurement-criteria being created from establishing a desired market and conducting market research into the desired-market, and wherein the market research includes gathering market-data, identifying at least one talented-candidate within the desired-market, and gathering candidate-data from the at least one talented-candidate; and
using the measurement-criteria to measure the employers' said success at attracting and retaining said candidate and employees.

17. The method of claim 1, further comprising the steps of:
recording at least one result from the measurement-criteria on the template.

18. The method of claim 17, further comprising the steps of:
using the at least one result from the measurement-criteria to actuate growth of the employer within the desired-market.

19. The method of claim 1, wherein the market research further includes gathering employer-data.

20. The method of claim 19, wherein the market research further includes identifying at least one employee of the employer; and gathering employee-data from the at least one employee.
